(19) United States
(12) Patent Application Publication
(10) Pub. No.: US 2020/0003939 A1
(43) Pub. Date: Jan. 2, 2020

(54) NON-COLOR SHIFTING MULTILAYER STRUCTURAL COLOR

(71) Applicant: Toyota Motor Engineering & Manufacturing North America, Inc., Plano, TX (US)

(72) Inventors: Debasish Banerjee, Ann Arbor, MI (US); Songtao Wu, Ann Arbor, MI (US)

(73) Assignee: Toyota Motor Engineering & Manufacturing North America, Inc.,, Plano, TX (US)

(21) Appl. No.: 16/024,169

(22) Filed: Jun. 29, 2018

(51) Int. Cl. G02B 5/26; G02B 5/08

(52) U.S. Cl. CPC G02B 5/26; G02B 5/0808

(57) ABSTRACT

A multilayer thin film that reflects an omnidirectional structural color including a reflective core layer; a dielectric absorbing layer extending across the reflective core layer; a semi-transparent absorbing layer extending across the dielectric absorbing layer; and an outer layer extending across the semi-transparent absorbing layer. The outer layer is formed from a dielectric material or a dielectric absorbing material, and the multilayer thin film reflects a single narrow band of visible light having a hue between 0° and 120° in the Lab color space, and a color shift less than 30° measured in Lab color space when the multilayer stack is viewed from angles between 0° and 45° relative to a direction normal to an outer surface of the multilayer thin film. The multilayer thin film may include a protective layer positioned between the reflective core layer and the dielectric absorbing layer.

### FIELD

The present application is related to multilayer thin film structures, and in particular to multilayer thin film structures that exhibit a minimum or non-noticeable color shift when exposed to broadband electromagnetic radiation and viewed from different angles.

### BACKGROUND

Pigments made from multilayer structures are known. In addition, pigments that exhibit or provide a high-chroma omnidirectional structural color are also known. However, such pigments are difficult to form in the deep red hue region (such as hue between 0° and) 120° with a narrow range of color shift when exposed to broadband electromagnetic radiation and viewed from different angles.

It is appreciated that the color produced by multilayer thin film structures is dependent on the materials used as the various layers, the location of materials within the multilayer thin film structure, and the properties of the individual layers (e.g., thickness). Accordingly, small variations in multilayer thin film structure design can have a distinct impact on the color produced by the multilayer thin film structure. However, conventional deposition techniques are not always effective for depositing the desired layers within a multilayer thin film structure to achieve the best combinations for omnidirectional multilayer thin films.

### SUMMARY

According embodiments, a multilayer thin film that reflects an omnidirectional structural color comprises: a reflective core layer; a dielectric absorbing layer extending across the reflective core layer; a semi-transparent absorbing layer extending across the dielectric absorbing layer; and an outer layer extending across the transparent absorbing layer, wherein the outer layer is formed from a dielectric material, wherein the multilayer thin film reflects a single narrow band of visible light when exposed to broadband electromagnetic radiation, the single narrow band of visible light comprising: a hue between 0° and 120° in the Lab color space; a color shift of the reflected single narrow band of visible light is less than 30° measured in Lab color space when the multilayer stack is exposed to broadband electromagnetic radiation and viewed from angles between 0° and 45° relative to a direction normal to an outer surface of the multilayer thin film.

In some embodiments, a multilayer thin film that reflects an omnidirectional structural color comprises: a reflective core layer formed from Al; a dielectric absorbing layer formed from Fe₂O₃ extending across the reflective core layer; a transparent absorbing layer formed from W extending across the dielectric absorbing layer; and an outer layer formed from ZnS, TiO₂, or combinations thereof extending across the transparent absorbing layer, wherein the multilayer thin film reflects a single narrow band of visible light when exposed to broadband electromagnetic radiation, the single narrow band of visible light comprising: a hue between 0° and 120° in the Lab color space; a color shift of the reflected single narrow band of visible light is less than 30° measured in Lab color space when the multilayer stack is exposed to broadband electromagnetic radiation and viewed from angles between 0° and 45° relative to a direction normal to an outer surface of the multilayer thin film.

According to other embodiments, a multilayer thin film that reflects an omnidirectional structural color comprises: a reflective core layer; a protective layer encapsulating (i.e., extending across and around) the reflective core layer; a dielectric absorbing layer extending across at least a portion of the protective layer; a semi-transparent absorbing layer extending across the dielectric absorbing layer; and an outer layer extending across the semi-transparent absorbing layer, wherein the outer layer is formed from a dielectric absorbing material, wherein the multilayer thin film reflects a single narrow band of visible light when exposed to broadband electromagnetic radiation, the single narrow band of visible light comprising: a hue between 0° and 120° in the Lab color space; a color shift of the reflected single narrow band of visible light is less than 30° measured in Lab color space when the multilayer stack is exposed to broadband electromagnetic radiation and viewed from angles between 0° and 45° relative to a direction normal to an outer surface of the multilayer thin film.

In some embodiments, a multilayer thin film that reflects an omnidirectional structural color comprises: a reflective core layer formed from Al; a protective layer formed from SiO₂ encapsulating the reflective core layer; a dielectric absorbing layer formed from Fe₂O₃ extending across at least a portion of the protective layer; a semi-transparent absorbing layer formed from W extending across the dielectric absorbing layer; and an outer layer formed from a high refractive index material, such as Fe₂O₃, TiO₂, or ZnS, extending across the semi-transparent absorbing layer, wherein the multilayer thin film reflects a single narrow band of visible light when exposed to broadband electromagnetic radiation, the single narrow band of visible light comprising: a hue between 0° and 120° in the Lab color space; a color shift of the reflected single narrow band of visible light is less than 30° measured in Lab color space when the multilayer stack is exposed to broadband electromagnetic radiation and viewed from angles between 0° and 45° relative to a direction normal to an outer surface of the multilayer thin film.

Additional features and advantages will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1A and FIG. 1B are schematic cross sections of a multilayer thin film structure according to embodiments disclosed and described herein;

FIG. 2A depicts a multilayer thin film with a dielectric layer extending over a reflective core layer used in the design of a multilayer thin film;

FIG. 2B depicts a multilayer thin film with a semiconductor absorbing layer extending over a reflective core layer used in the design of a multilayer thin film;

FIG. 2C depicts a multilayer thin film with a dielectric absorbing layer extending over a reflective core layer used in the design of multilayer thin films according to one or more embodiments shown and described herein;

FIG. 3 depicts reflectance properties of the multilayer thin films illustrated in FIGS. 2A-2C on a Lab color space;

FIG. 4A graphically depicts chroma and hue values as a function of dielectric layer thickness for the multilayer thin film illustrated in FIG. 2A;

FIG. 4B graphically depicts chroma and hue values as a function of semiconductor absorbing layer thickness for the multilayer thin film illustrated in FIG. 2B;

FIG. 4C graphically depicts chroma and hue values as a function of dielectric absorbing layer thickness for the multilayer thin film illustrated in FIG. 2C;

FIG. 5 depicts a multilayer thin film with a dielectric layer extending over a substrate layer and exposed to electromagnetic radiation at an angle θ relative to a normal direction to the outer surface of the dielectric layer; and

FIG. 6 graphically depicts percent reflectance as a function of wavelength for a multilayer thin film illuminated with white light and viewed at 0° and 45° relative to a direction that is normal to an outer surface of the multilayer thin film according to one or more embodiments shown and described herein.

### DETAILED DESCRIPTION

A structure that produces omnidirectional structural color is provided in this disclosure. The structure that produces omnidirectional structural color has the form of a multilayer thin film (also referred to as a multilayer stack herein) that reflects a narrow band of electromagnetic radiation in the visible spectrum and has a small or non-noticeable hue shift when the multilayer thin film is viewed from angles between 0 to 45 degrees. The multilayer thin film can be used as pigment in composition (such as, for example, a paint composition), a continuous thin film on a structure, and the like.

The multilayer thin film structures described herein may be used to omnidirectionally reflect wavelengths within the red spectrum of visible light over a range of angles of incidence or viewing (such as hues between 0° and 120°). It will be understood that the terms “electromagnetic wave,” “electromagnetic radiation,” and “light,” as used herein, may interchangeably refer to various wavelengths of light incidence on a multilayer thin film structure and that such light may have wavelengths in the ultraviolet (UV), infrared (IR), and visible portions of the electromagnetic spectrum.

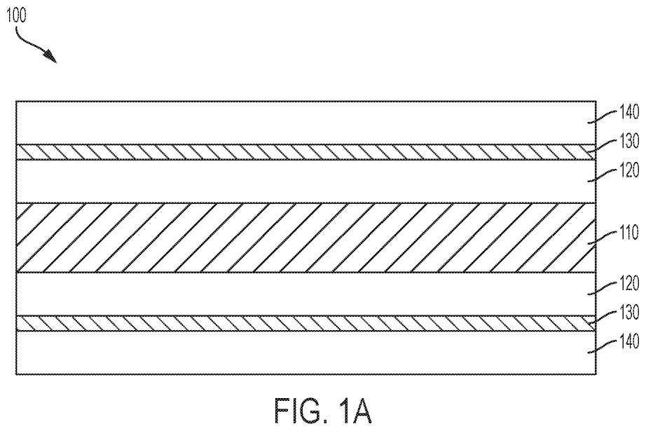

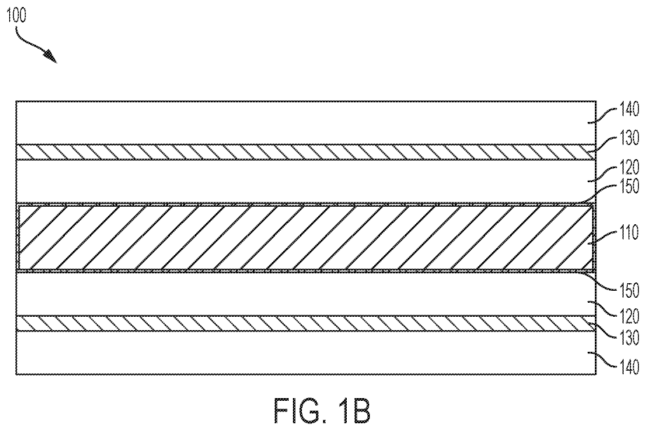

Referring now to FIG. 1A, a multilayer thin film 100 according to embodiments disclosed and described herein comprises a reflective core layer 110, at least one dielectric absorbing layer 120 that extends across the reflective core layer 110, at least one semi-transparent absorbing layer 130 that extends across the at least one dielectric absorbing layer 120, and at least one outer layer 140 that extends across the at least one semi-transparent absorbing layer 130. In embodiments, the outer layer may be a dielectric layer, and in other embodiments, the outer layer may be a dielectric absorbing layer.

In some embodiments, and with reference to FIG. 1B, the multilayer thin film 100 comprises a reflective core layer 110, a protective layer 150 that encapsulates the reflective core layer 110, at least one dielectric absorbing layer 120 that extends across at least a portion of the protective layer 150, at least one absorbing layer 130 that extends across the at least one dielectric absorbing layer 120, and at least one outer layer 140 that extends across the at least one absorbing layer. In embodiments, the outer layer may be a dielectric layer, and in other embodiments, the outer layer may be a dielectric absorbing layer.

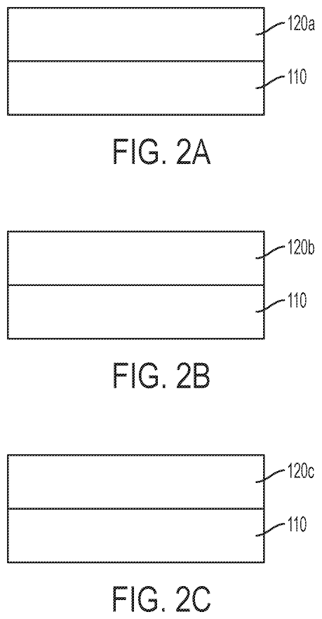

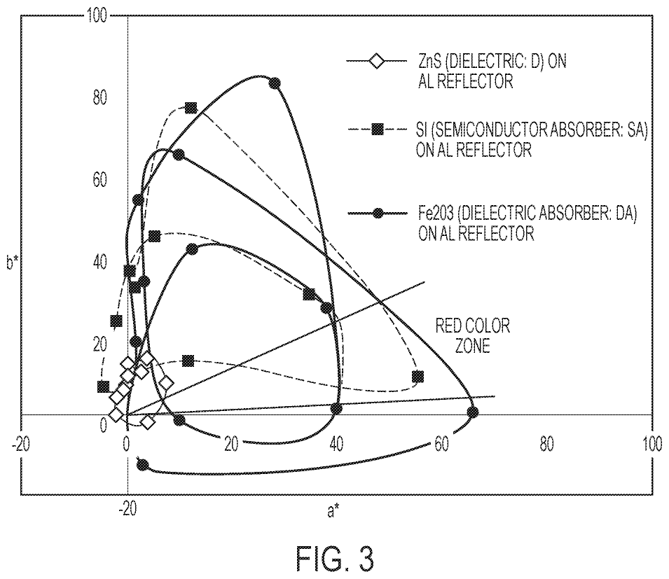

Referring to FIGS. 2A-2C and 3, the effectiveness of different types of layers extending across a reflective core layer 110 in attaining a desired hue level in a red region of the visible light spectrum as plotted or shown on a Lab color space is depicted. FIG. 2A depicts a ZnS dielectric layer 120a extending across a reflective core layer 110, FIG. 2B depicts a Si semiconductor absorbing layer 120b extending across a reflective core layer 110, and FIG. 2C depicts an Fe₂O₃ dielectric absorbing layer 120c extending across a reflective core layer 110. Simulations of the reflectance from each multilayer thin film illustrated in FIGS. 2A-2C are performed as a function of different thicknesses for the dielectric layer 120a, the semiconductor absorbing layer 120b, and dielectric absorbing layer 120c. The results of the simulations are plotted on a Lab color space, also known as an a*b* color map, shown in FIG. 3. Each data point shown in FIG. 3 provides a chroma and a hue for particular thickness of the dielectric layer for the multilayer thin film depicted in FIG. 2A, the semiconductor absorbing layer for the multilayer thin film depicted in FIG. 2B or the dielectric absorbing layer for the multilayer thin film depicted in FIG. 2C. Chroma can be defined as C=\sqrt{(a*²+b*²)} and hue can be defined as tan⁻¹(a*/b*). The hue can also be referred to as the angle relative to the positive a*-axis of a given data point. A hue value provides a measure of the color displayed by an object (e.g., red, green, blue, yellow etc.), and a chroma value provides a measure of the color's “brightness.” As shown in FIG. 3, the multilayer thin film illustrated in FIG. 2A provides low chroma compared to the multilayer thin films illustrated in FIGS. 2B and 2C. Accordingly, FIGS. 2A-2C and FIG. 3 demonstrate that an absorbing layer, (e.g., a dielectric absorbing layer) is preferred over a dielectric layer as a first layer extending over a reflective core layer when colors with high chroma are desired.

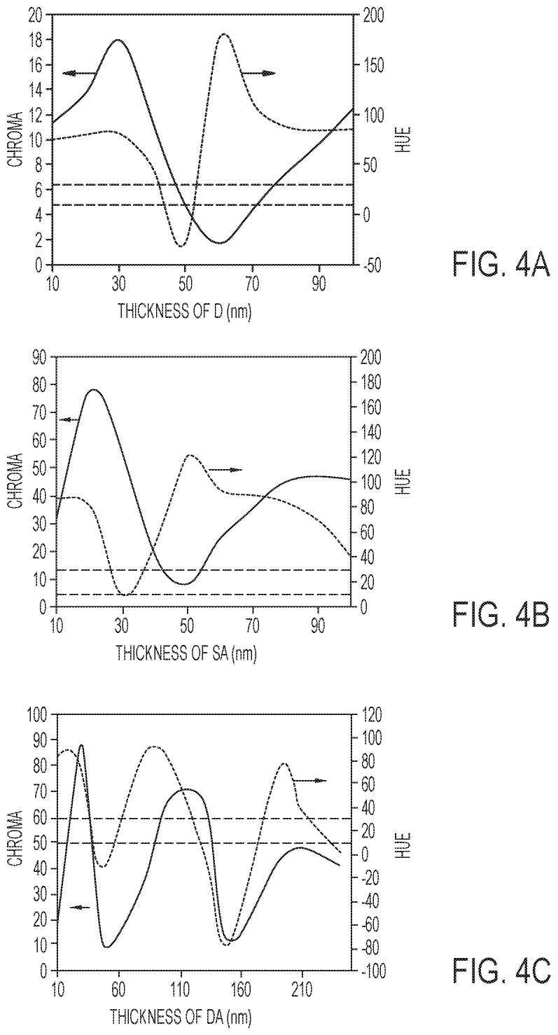

Referring to FIGS. 4A-4C, chroma and hue as a function of layer thickness is depicted. Specifically, FIG. 4A graphically depicts the chroma and hue as a function of the thickness of the ZnS dielectric layer extending over the Al reflective core layer illustrated in FIG. 2A. FIG. 4B depicts the chroma and hue as a function of the thickness of the Si semiconductor absorbing layer extending over the Al reflective core layer illustrated in FIG. 2B. FIG. 4C depicts the chroma and hue as a function of the thickness of the Fe₂O₃ dielectric absorbing layer extending over the Al reflective core layer illustrated in FIG. 2C. The dotted lines in FIGS. 4A-4C correspond to desired hue values between 10° and 30° on the Lab color space. FIGS. 4A-4C illustrate that higher chroma values within the hue range between 10° and 30° are achieved for multilayer thin films having a dielectric absorbing layer extending across the reflective core layer.

In embodiments, and with reference again to FIG. 1, an absorbing layer 130 extends between the dielectric absorbing layer 120 and the outer layer 140. The location of the absorbing layer 130 is chosen to increase the absorption of light wavelengths less than or equal to 550 nm but reflect light wavelengths of approximately 650 nm, such as visible light outside of the hue between 10° and 30°. Accordingly, the absorbing layer is placed at a thickness where the electric field (|E|²) is less at the 550 nm wavelength than at the 650 nm wavelength. Mathematically, this can be expressed as:

|E₅₅₀|²<<|E₆₅₀|² (1)

and preferably:

|E₆₅₀|²≈0 (2)

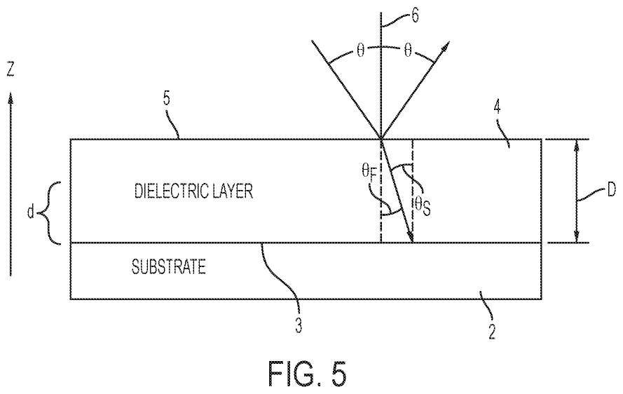

FIG. 5 and the following discussion provide a method for calculating the thickness of a zero or near-zero electric field point at a given wavelength of light, according to embodiments. For the purposes of the present specification, the term “near-zero” is defined |E|²≤10. FIG. 5 illustrates a multilayer thin film with a dielectric layer 4 having a total thickness “D”, an incremental thickness “d” and an index of refraction “n” on a substrate layer 2 having an index of refraction “nₛ”. The substrate layer 2 can be a core layer or a reflective core layer of a multilayer thin film. Incident light strikes the outer surface 5 of the dielectric layer 4 at angle θ relative to line 6, which is perpendicular to the outer surface 5, and reflects from the outer surface 5 at the same angle θ. Incident light is transmitted through the outer surface 5 and into the dielectric layer 4 at an angle θ_{F} relative to the line 6 and strikes the surface 3 of substrate layer 2 at an angle θₛ. For a single dielectric layer, θₛ=θ_{F} and the energy/electric field (E) can be expressed as E(z) when z=d. From Maxwell's equations, the electric field can be expressed for s polarization as:

E^{ω}(d)={u(z),0,0}exp(ik,αy)_{z=d} (3)

and for p polarization as:

$${E}^{ω} ( d ) = \{ 0 , u ( z ) , - \frac{α}{\tilde{ɛ} ( z )} v ( z ) \} exp ( ik α y ) {\vert}_{z = d} \qquad ( 4 )$$

where

$$k = \frac{2 π}{λ} ,$$

λ is a desired wavelength to be reflected, α=nₛ sin θₛ where “s” corresponds to the substrate in FIG. 5, and \tilde{ε}(z) is the permittivity of the layer as a function of z. As such:

|E(d)|²=|u(z)|²exp(2ikαy)_{z=d} (5)

for s polarization, and

$${\vert E ( d ) \vert}^{2} = [ {\vert u ( z ) \vert}^{2} + {\vert \frac{α}{\sqrt{n}} v ( z ) \vert}^{2} ] exp ( 2 ik α y ) {\vert}_{z = d} \qquad ( 6 )$$

for p polarization.

It should be appreciated that variation of the electric field along the Z direction of the dielectric layer 4 can be estimated by calculation of the unknown parameters u(z) and v(z), where it can be shown that:

$${( \begin{matrix}u \\ v\end{matrix} )}_{z = d} = ( \begin{matrix}cos ϕ & ( i / q ) sin ϕ \\ iq sin ϕ & cos ϕ\end{matrix} ) {( \begin{matrix}u \\ v\end{matrix} )}_{z = 0 , substrate} \qquad ( 7 )$$

where ‘i’ is the square root of −1. Using the boundary conditions u|_{z=0}=1, v|_{z=0}=qₛ, and the following relations:

qₛ=nₛ cos θₛ for s-polarization (8)

qₛ=nₛ/cos θₛ for p-polarization (9)

q=n cos θ_{F} for s-polarization (10)

q=n/cos θ_{F} for p-polarization (11)

φ=k·n·d cos(θ_{F}) (12)

u(z) and v(z) can be expressed as:

$$\begin{matrix}u ( z ) {\vert}_{z = d} = u {\vert}_{z = 0} cos ϕ + v {\vert}_{z = 0} ( \frac{i}{q} sin ϕ ) = cos ϕ + \frac{{iq}_{s}}{q} sin ϕ \\ and & ( 13 ) \\ v ( z ) {\vert}_{z = d} = iqu {\vert}_{z = 0} sin ϕ + v {\vert}_{z = 0} cos ϕ = iq sin ϕ + {q}_{s} cos ϕ & ( 14 )\end{matrix}$$

### Therefore:

$${\vert E ( d ) \vert}^{2} = [ {cos}^{2} ϕ + \frac{{q}_{s}^{2}}{{q}^{2}} {sin}^{2} ϕ ] {e}^{2 ik α y} = [ {cos}^{2} ϕ + \frac{{n}_{s}^{2}}{{n}^{2}} {sin}^{2} ϕ ] {e}^{2 ik α y} \qquad ( 15 )$$

for s polarization with φ=k·n·d cos(θ_{F}), and:

$${\vert E ( d ) \vert}^{2} = [ {cos}^{2} ϕ + \frac{{n}_{s}^{2}}{{n}^{2}} {sin}^{2} ϕ + \frac{{α}^{2}}{n} ( {q}_{s}^{2} {cos}^{2} ϕ + {q}^{2} {sin}^{2} ϕ ) ] = [ ( 1 + \frac{{α}^{2} {q}_{s}^{2}}{n} ) {cos}^{2} ϕ + ( \frac{{n}_{s}^{2}}{{n}^{2}} + \frac{{α}^{2} {q}^{2}}{n} ) {sin}^{2} ϕ ] \qquad ( 16 )$$

for p polarization where:

$$\begin{matrix}α = {n}_{s} sin {θ}_{s} = n sin {θ}_{F} & ( 17 ) \\ {q}_{s} = \frac{{n}_{s}}{cos {θ}_{s}} \\ and & ( 18 ) \\ {q}_{s} = \frac{n}{cos {θ}_{F}} & ( 19 )\end{matrix}$$

Thus for a simple situation where θ_{F}=0 or normal incidence, φ=k·n·d, and α=0:

$$\begin{matrix} {\vert E ( d ) \vert}^{2} \text{for s-polarization} = {\vert E ( d ) \vert}^{2} & ( 20 ) \\ \text{for p-polarization} = [ {cos}^{2} ϕ + \frac{{n}_{s}^{2}}{{n}^{2}} {sin}^{2} ϕ ] = [ {cos}^{2} ( k \cdot n \cdot d ) + \frac{{n}_{s}^{2}}{{n}^{2}} {sin}^{2} ( k \cdot n \cdot d ) ] & ( 21 )\end{matrix}$$

which allows for the thickness “d” to be solved for (i.e., the position or location within the dielectric layer where the electric field is zero). It should be appreciated that the thickness “d” can also be the thickness of the outer layer 140 extending over the absorbing layer 130 that provides a zero or near zero electric field at the interface between the outer layer and the semi-transparent absorbing layer 130.

Referring again to FIG. 1A, a multilayer thin film 100 that reflects an omnidirectional high chroma red structural color according to embodiments is shown. The multilayer thin film 100 includes a reflective core layer 110, a dielectric absorbing layer 120 extending across the reflective core layer 110, a semi-transparent absorbing layer 130 extending across the dielectric absorbing layer 120, and an outer layer 140 extending across the at least one semi-transparent absorbing layer 130. In embodiments, the “outer layer” has an outer free surface (i.e., an outer surface not in contact with an absorbing layer or another dielectric layer that is not part of a protective coating). It should be appreciated that in embodiments two dielectric absorbing layers 120, two semi-transparent absorbing layers 130, and two outer layers 140 can be located on opposing sides of the reflective core layer 110 such that the reflective core layer 110 is a core layer sandwiched between a pair of dielectric absorbing layers 120, a pair of semi-transparent absorbing layers 130, and a pair of outer layers 140. Such a multilayer thin film with a reflective core layer 110 sandwiched between a pair of dielectric absorbing layers 120, a pair of semi-transparent absorbing layers 130, and a pair of outer layers can be referred to as a seven-layer multilayer thin film.

The reflective core layer 110 can, in embodiments, have a thickness between 50 nm and 200 nm, such as between 75 nm and 200 nm, between 100 nm and 200 nm, between 125 nm and 200 nm, between 150 nm and 200 nm, or between 175 and 200 nm. In other embodiments, the reflective core layer 110 can have a thickness between 50 nm and 175 nm, such as between 50 nm and 150 nm, between 50 nm and 125 nm, between 50 nm and 100 nm, or between 50 and 75 nm. In some embodiments, the reflective core layer 110 can have a thickness between 75 nm and 175 nm, such as between 100 nm and 150 nm. In embodiments, the reflective core layer 110 can be made from at least one of a “gray metallic” material, such as Al, Ag, Pt, Sn; at least one of a “colorful metallic” material, such as Au, Cu, brass, bronze, TiN, Cr, or a combination thereof.

The at least one dielectric absorbing layer 120 can, according to embodiments, have a thickness between 5 and 500 nm, such as between 50 nm and 500 nm, between 100 nm and 500 nm, between 150 nm and 500 nm, between 200 nm and 500 nm, between 250 nm and 500 nm, between 300 nm and 500 nm, between 350 nm and 500 nm, between 400 nm and 500 nm, or between 450 nm and 500 nm. In some embodiments, the at least one dielectric absorbing layer 120 can have a thickness between 5 nm and 450 nm, such as between 5 nm and 400 nm, between 5 nm and 350 nm, between 5 nm and 300 nm, between 5 nm and 250 nm, between 5 nm and 200 nm, between 5 nm and 150 nm, between 5 nm and 100 nm, or between 5 nm and 50 nm. In embodiments, the dielectric absorbing layer can have a thickness between 50 nm to 450 nm, such as between 100 nm to 400 nm, between 150 nm to 350 nm, or between 200 nm to 300 nm. In embodiments, the dielectric absorbing layer 120 can be made from at least one colorful dielectric material such as Fe₂O₃, TiN, or a combination thereof. In embodiments, the at least one dielectric absorbing layer 120 can be deposited across the reflective core layer 110 by chemical vapor deposition (CVD), atomic layer deposition (ALD), plasma enhanced CVD (PECVD), physical vapor deposition (PVD), e-beam deposition, etc.

The at least one semi-transparent absorbing layer 130 can, in embodiments, have a thickness from 5 nm to 20 nm, such as from 10 nm to 20 nm, or from 15 nm to 20 nm. In embodiments, the semi-transparent absorbing layer can have a thickness from 5 nm to 15 nm, such as from 5 nm to 10 nm, or from 10 nm to 15 nm. In embodiments, the semi-transparent absorbing layer 130 can be made from at least one material selected from W, Cr, Ge, Ni, stainless steel, Pd, Ti, Si, V, TiN, Co, Mo, Nb, ferric oxide, amorphous silicon, or combinations thereof. In embodiments, the at least one semi-transparent absorbing layer 130 can be deposited across the dielectric absorbing layer 120 by ALD, sputtering, PVD, e-beam deposition, PECVD, etc.

The at least one outer layer 140 can, in embodiments, have a thickness greater than 0.1 quarter wave (QW) to less than or equal to 4.0 QW where the control wavelength is determined by the target wavelength at the peak reflectance in the visible wavelength, such as between 0.5 QW and 4.0 QW, between 1.0 QW and 4.0 QW, between 1.5 QW and 4.0 QW, between 2.0 QW and 4.0 QW, between 2.5 QW and 4.0 QW, between 3.0 QW and 4.0 QW, or between 3.5 QW and 4.0 QW. In embodiments, the at least one outer layer 140 can have a thickness from greater than 0.1 QW to less than 3.5 QW, such as from greater than 0.1 QW to less than 3.0 QW, from greater than 0.1 QW to less than 2.5 QW, from greater than 0.1 QW to less than 2.0 QW, from greater than 0.1 QW to less than 1.5 QW, from greater than 0.1 QW to less than 1.0 QW, or from greater than 0.1 QW to less than 0.5 QW. In some embodiments, the at least one outer layer 140 can have a thickness from 0.5 QW to 3.5 QW, such as from 1.0 QW to 3.0 QW, or from 1.5 QW to 2.5 QW. In embodiments, the target wavelength may be about 1050 nm. The outer dielectric layer can be made from a dielectric material with a refractive index greater than 1.6 such as ZnS, ZrO₂, CeO₂ HfO₂, TiO₂, or combinations thereof. In embodiments, the outer layer may be deposited by chemical vapor deposition techniques or by atomic layer deposition techniques.

Embodiments of the multilayer thin film 100 described above have a hue shift of less than 30°, such as less than 25°, less than 20°, less than 15°, or less than 10° in the Lab color space when viewed at angles from 0° to 45°.

In one or more embodiments, the multilayer thin film 100 comprises a reflective core layer 110 made from Al, a dielectric absorbing layer 120 made from Fe₂O₃ extending across the reflective core layer 110, a semi-transparent absorbing layer 130 made from W extending across the dielectric absorbing layer 120, and an outer layer 140 made from ZnS extending across the semi-transparent absorbing layer 130.

In one or more embodiments, the multilayer thin film 100 comprises a reflective core layer 110 made from Al, a dielectric absorbing layer 120 made from Fe₂O₃ extending across the reflective core layer 110, a semi-transparent absorbing layer 130 made from W extending across the dielectric absorbing layer 120, and an outer layer 140 made from TiO₂ extending across the semi-transparent absorbing layer 130.

Referring now to FIG. 1B, a multilayer thin film 100 that reflects an omnidirectional high chroma red structural color according to embodiments is shown. The multilayer thin film 100 includes a reflective core layer 110, a protective layer 150 encapsulating the reflective core layer 110, a dielectric absorbing layer 120 extending across at least a portion of the protective layer 150, a semi-transparent absorbing layer 130 extending across the dielectric absorbing layer 120, and an outer layer 140 extending across the at least one semi-transparent absorbing layer 130. In embodiments, the “outer layer” has an outer free surface (i.e., an outer surface not in contact with an absorbing layer or another dielectric layer that is not part of a protective coating). It should be appreciated that in embodiments two protective layers 150, two dielectric absorbing layers 120, two semi-transparent absorbing layers 130, and two outer layers 140 can be positioned on opposing sides of the reflective core layer 110 such that the reflective core layer 110 is a core layer sandwiched between a pair of protective layers 150, a pair of dielectric absorbing layers 120, a pair of semi-transparent absorbing layers 130, and a pair of outer layers 140. Such a multilayer thin film with a reflective core layer 110 sandwiched between a pair of protective layers 150, a pair of dielectric absorbing layers 120, a pair of semi-transparent absorbing layers 130, and a pair of outer layers can be referred to as a nine-layer multilayer thin film.

The reflective core layer 110 can, in embodiments, have a thickness between 50 nm and 200 nm, such as between 75 nm and 200 nm, between 100 nm and 200 nm, between 125 nm and 200 nm, between 150 nm and 200 nm, or between 175 and 200 nm. In other embodiments, the reflective core layer 110 can have a thickness between 50 nm and 175 nm, such as between 50 nm and 150 nm, between 50 nm and 125 nm, between 50 nm and 100 nm, or between 50 and 75 nm. In some embodiments, the reflective core layer 110 can have a thickness between 75 nm and 175 nm, such as between 100 nm and 150 nm. In embodiments, the reflective core layer 110 can be made from at least one of a “gray metallic” material, such as Al, Ag, Pt, Sn; at least one of a “colorful metallic” material, such as Au, Cu, brass, bronze, TiN, Cr, or combinations thereof.

The at least one protective layer 150 can, in embodiments, have a thickness between 5 nm and 70 nm, such as between 10 nm and 70 nm, between 15 nm and 70 nm, between 20 nm and 70 nm, between 25 nm and 70 nm, between 30 nm and 70 nm, between 35 nm and 70 nm, between 40 nm and 70 nm, between 45 nm and 70 nm, between 50 nm and 70 nm, between 55 nm and 70 nm, between 60 nm and 70 nm, or between 65 nm and 70 nm. In embodiments, the at least one protective layer 150 can have a thickness between 5 nm and 65 nm, such as between 5 nm and 60 nm, between 5 nm and 55 nm, between 5 nm and 50 nm, between 5 nm and 45 nm, between 5 nm and 40 nm, between 5 nm and 35 nm, between 5 nm and 30 nm, between 5 nm and 25 nm, between 5 nm and 20 nm, between 5 nm and 15 nm, or between 5 nm and 10 nm. In embodiments, the at least one protective layer 150 can have a thickness between 10 nm and 65 nm, such as between 15 nm and 60 nm, between 20 nm and 55 nm, between 25 nm and 50 nm, between 30 nm and 45 nm, or between 35 nm and 40 nm. In some embodiments, the protective layer can be made from SiO₂, Al₂O₃, CeO₂, ZrO₂ or combinations thereof. In embodiments, the protective layer 150 may be deposited across the reflective core layer 110 by wet chemistry deposition techniques, such as sol gel deposition techniques.

Without being bound by any particular theory, it is believed that the protective layer 150 is necessary in embodiments where a dielectric absorbing layer 120 (e.g., a Fe₂O₃ dielectric absorbing layer 120) extends across the reflective core layer 110 because the process for crystallizing the dielectric absorbing layer 120 generally takes place at high temperatures that can damage the reflective core layer 110 (e.g., an Al reflective core layer) such as by oxidizing or deforming the reflective core layer 110. The protective layer 150 shields the reflective core layer 110 from the damage caused by the highly basic/acidic conditions of, for example, wet chemical deposition. However, the addition of a protective layer 150 (e.g., an SiO₂ protective layer) can alter the reflectance of the reflective core layer 110. In embodiments, the change in reflectance caused by the protective layer 150 can be compensated for by adding a corresponding semi-transparent absorbing layer 130 (e.g., a W semi-transparent absorbing layer) and an outer layer made from a dielectric absorbing material (e.g., an Fe₂O₃ outer layer).

The at least one dielectric absorbing layer 120 can, according to embodiments, have a thickness between 5 and 500 nm, such as between 50 nm and 500 nm, between 100 nm and 500 nm, between 150 nm and 500 nm, between 200 nm and 500 nm, between 250 nm and 500 nm, between 300 nm and 500 nm, between 350 nm and 500 nm, between 400 nm and 500 nm, or between 450 nm and 500 nm. In some embodiments, the at least one dielectric absorbing layer 120 can have a thickness between 5 nm and 450 nm, such as between 5 nm and 400 nm, between 5 nm and 350 nm, between 5 nm and 300 nm, between 5 nm and 250 nm, between 5 nm and 200 nm, between 5 nm and 150 nm, between 5 nm and 100 nm, or between 5 nm and 50 nm. In embodiments, the dielectric absorbing layer can have a thickness between 50 nm to 450 nm, such as between 100 nm to 400 nm, between 150 nm to 350 nm, or between 200 nm to 300 nm. In embodiments, the dielectric absorbing layer 120 can be made from at least one colorful dielectric material such as Fe₂O₃, TiN, or a combination thereof. In embodiments, the at least one dielectric absorbing layer 120 can be deposited across the reflective core layer 110 by wet chemistry deposition techniques, such as sol gel deposition techniques, or by ALD, sputtering, PVD, e-beam deposition, PECVD, etc.

The at least one semi-transparent absorbing layer 130 can, in embodiments, have a thickness from 5 nm to 20 nm, such as from 10 nm to 20 nm, or from 15 nm to 20 nm. In embodiments, the semi-transparent absorbing layer can have a thickness from 5 nm to 15 nm, such as from 5 nm to 10 nm, or from 10 nm to 15 nm. In embodiments, the semi-transparent absorbing layer 130 can be made from at least one material selected from W, Cr, Ge, Ni, stainless steel, Pd, Ti, Si, V, TiN, Co, Mo, Nb, ferric oxide, amorphous silicon, or combinations thereof. In embodiments, the at least one semi-transparent absorbing layer 130 can be deposited across the dielectric absorbing layer 120 by ALD, sputtering, PVD, e-beam deposition, PECVD, etc.

The at least one outer layer 140 can, in embodiments, have a thickness greater than 0.1 quarter wave (QW) to less than or equal to 4.0 QW where the control wavelength is determined by the target wavelength at the peak reflectance in the visible wavelength, such as between 0.5 QW and 4.0 QW, between 1.0 QW and 4.0 QW, between 1.5 QW and 4.0 QW, between 2.0 QW and 4.0 QW, between 2.5 QW and 4.0 QW, between 3.0 QW and 4.0 QW, or between 3.5 QW and 4.0 QW. In embodiments, the at least one outer layer 140 can have a thickness from greater than 0.1 QW to less than 3.5 QW, such as from greater than 0.1 QW to less than 3.0 QW, from greater than 0.1 QW to less than 2.5 QW, from greater than 0.1 QW to less than 2.0 QW, from greater than 0.1 QW to less than 1.5 QW, from greater than 0.1 QW to less than 1.0 QW, or from greater than 0.1 QW to less than 0.5 QW. In some embodiments, the at least one outer layer 140 can have a thickness from 0.5 QW to 3.5 QW, such as from 1.0 QW to 3.0 QW, or from 1.5 QW to 2.5 QW. In embodiments, the target wavelength may be about 1050 nm. The outer dielectric layer can be made from a dielectric material with a refractive index greater than 1.6 such as ZnS, CeO₂, ZrO₂, TiO₂, or combinations thereof. In embodiments, the outer layer may be deposited by wet chemistry deposition techniques, such as sol gel deposition techniques or by ALD, sputtering, PVD, e-beam deposition, PECVD, etc.

In other embodiments, the outer layer 140 can have a thickness between 5 and 500 nm, such as between 50 nm and 500 nm, between 100 nm and 500 nm, between 150 nm and 500 nm, between 200 nm and 500 nm, between 250 nm and 500 nm, between 300 nm and 500 nm, between 350 nm and 500 nm, between 400 nm and 500 nm, or between 450 nm and 500 nm. In some embodiments, the at least one dielectric absorbing layer 120 can have a thickness between 5 nm and 450 nm, such as between 5 nm and 400 nm, between 5 nm and 350 nm, between 5 nm and 300 nm, between 5 nm and 250 nm, between 5 nm and 200 nm, between 5 nm and 150 nm, between 5 nm and 100 nm, or between 5 nm and 50 nm. In embodiments, the dielectric absorbing layer can have a thickness between 50 nm to 450 nm, such as between 100 nm to 400 nm, between 150 nm to 350 nm, or between 200 nm to 300 nm. In embodiments, the dielectric absorbing layer 120 can be made from at least one colorful dielectric material such as Fe₂O₃, TiN, or a combination thereof. In embodiments, the outer layer may be deposited by wet chemistry deposition techniques, such as sol gel deposition techniques, or by ALD, sputtering, PVD, e-beam deposition, PECVD, etc.

Embodiments of the multilayer thin film 100 described above have a hue shift of less than 30°, such as less than 25°, less than 20°, less than 15°, or less than 10° in the Lab color space when viewed at angles from 0° to 45°.

In one or more embodiments, the multilayer thin film 100 comprises a reflective core layer 110 made from Al, a protective layer 150 made from SiO₂ encapsulating the reflective core layer 110, a dielectric absorbing layer 120 made from Fe₂O₃ extending across at least a portion of the protective layer 150, a semi-transparent absorbing layer 130 made from W extending across the dielectric absorbing layer 120, and an outer layer 140 made from Fe₂O₃ extending across the semi-transparent absorbing layer 130.

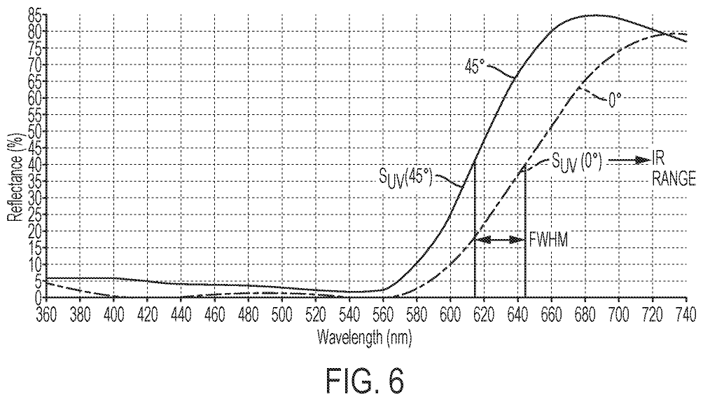

Referring now to FIG. 6, a representative reflectance spectrum in the form of percent reflectance versus reflected light wavelength provided by a multilayer thin film having an Al reflective core layer, a SiO₂ protective layer having a thickness of 0.3 QW (at a control wavelength of 960 nm) encapsulating the reflective core layer, an Fe₂O₃ dielectric absorbing layer extending across at least a portion of the protective layer and having a thickness of 0.8 QW (at a control wavelength of 960 nm), a W semi-transparent absorbing layer having a thickness of 0.12 QW (at a control wavelength of 960 nm) extending across the dielectric absorbing layer, and an outer layer of Fe₂O₃ having a thickness of 0.4 QW (at a control wavelength of 960 nm) extending across the semi-transparent absorbing layer. The multilayer thin film is illuminated with white light at angles of 0° and 45° relative to the direction that is normal to an outer surface of a multilayer thin film is shown. As shown by the reflectance spectrum, both the 0° and 45° curves illustrate very low reflectance (e.g., less than 10%) for wavelengths less than 550 nm. However, a sharp increase in reflectance at wavelengths between 560 nm and 660 nm that reaches a maximum of approximately 85% at between 690 nm and 740 nm is observed.

It is appreciated that the portion or region of the graph on the right hand side (IR side) of the curve represents the IR-portion of the reflection band provided by embodiments. The sharp increase in reflectance is characterized by a UV-sided edge of the 0° curve (S))_{UV}(0°)) and the 45° curve))(S_{UV}(45°)) that extend from a low reflectance portion at wavelengths below 550 nm up to a high reflectance portion, for example greater than 70%, greater than 80%, or greater than 85% reflectance. A measure of the degree of omnidirectionality provided by embodiments can be the shift between S_{UV}(0°) and S_{UV}(45°) edges at the visible FWHM location. A zero shift (i.e., no shift between the S_{UV}(0°) and S_{UV}(45°) edges would characterize a perfectly omnidirectional multilayer thin film. However, a shift between S_{UV}(0°) and S_{UV}(45°) edges for embodiments disclosed herein is less than 100 nm, such as less than 75 nm, less 50 nm, or less than 25 nm, which to the human eye can appear as though the surface of the multilayer thin film does not changed color when viewed at angles between 0° and 45° and from a human eye perspective the multilayer thin film is omnidirectional. The reflection band has a visible FWHM of less than 300 nm, such as less than 200 nm, less than 150 nm, or less than 100 nm. The term “visible FWHM” refers to the width of the reflection band between the UV-sided edge of the curve and the edge of the IR spectrum range, beyond which reflectance provided by the omnidirectional reflector is not visible to the human eye. It should be appreciated that embodiments disclosed herein use the non-visible IR portion of the electromagnetic radiation spectrum to provide a sharp or structural color (i.e., embodiments disclosed herein take advantage of the non-visible IR portion of the electromagnetic radiation spectrum to provide a narrow band of reflected visible light, although a much broader band of electromagnetic radiation may extend into the IR region.)

The multilayer thin films in embodiments disclosed herein can be used as pigments (e.g., paint pigments for a paint used to paint an object), or a continuous thin film applied to an object. When used as pigments, at least one of paint binders and fillers can be used and mixed with the pigments to provide a paint that displays an omnidirectional high chroma red structural color. In addition, other additives may be added to the multilayer thin film to aid the compatability of multilayer thin film in the paint system. Exemplary compatability-enhancing additives include silane surface treatments that coat the exterior of the multilayer thin film and improve the compatability of multilayer thin film in the paint system. It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

What is claimed is:

1. A multilayer thin film that reflects an omnidirectional structural color comprising:
a reflective core layer;
a dielectric absorbing layer extending across the reflective core layer;
a semi-transparent absorbing layer extending across the dielectric absorbing layer; and
an outer layer extending across the semi-transparent absorbing layer, wherein the outer layer is formed from a dielectric material,
wherein the multilayer thin film reflects a single narrow band of visible light when exposed to broadband electromagnetic radiation, the single narrow band of visible light comprising:
a hue between 0° and 120° in the Lab color space;
a color shift of the single narrow band of visible light is less than 30° measured in Lab color space when the multilayer thin film is exposed to broadband electromagnetic radiation and viewed from angles between 0° and 45° relative to a direction normal to an outer surface of the multilayer thin film.

2. The multilayer thin film of claim 1, wherein the reflective core layer is formed from Al, Ag, Pt, Sn, Au, Cu, brass, bronze, TiN, Cr, or combinations thereof.

3. The multilayer thin film of claim 1, wherein the reflective core layer has a thickness between 50 nm and 200 nm.

4. The multilayer thin film of claim 1, wherein the dielectric absorbing layer is formed from Fe₂O₃, TiN, or combinations thereof.

5. The multilayer thin film of claim 1, wherein the dielectric absorbing layer has a thickness between 5 nm and 500 nm.

6. The multilayer thin film of claim 1, wherein the semi-transparent absorbing layer is formed from W, Cr, Ge, Ni, stainless steel, Pd, Ti, Si, V, TiN, Co, Mo, Nb, ferric oxide, amorphous silicon, or combinations thereof.

7. The multilayer thin film of claim 1, wherein the semi-transparent absorbing layer has a thickness between 5 nm and 20 nm.

8. The multilayer thin film of claim 1, wherein the outer layer is formed from a dielectric material selected from the group consisting of ZnS, ZrO₂, CeO₂, TiO₂, or combinations thereof.

9. The multilayer thin film of claim 1, wherein outer layer has a thickness greater than 0.1 quarter wave (QW) to less than or equal to 4.0 QW where a control wavelength is determined by a target wavelength at a peak reflectance in a visible wavelength.

10. The multilayer thin film of claim 1, wherein
the reflective core layer is formed from Al,
the dielectric absorbing layer is formed from Fe₂O₃,
the semi-transparent absorbing layer is formed from W, and
the outer layer is formed from ZnS, TiO₂, or combinations thereof.

11. A multilayer thin film that reflects an omnidirectional structural color comprising:
a reflective core layer;
a protective layer encapsulating the reflective core layer;
a dielectric absorbing layer extending across at least a portion of the protective layer;
a semi-transparent absorbing layer extending across the dielectric absorbing layer; and
an outer layer extending across the semi-transparent absorbing layer, wherein the outer layer is formed from a dielectric absorbing material or a dielectric material, wherein the multilayer thin film reflects a single narrow band of visible light when exposed to broadband electromagnetic radiation, the single narrow band of visible light comprising:
a hue between 0° and 120° in the Lab color space;
a color shift of the single narrow band of visible light is less than 30° measured in Lab color space when the multilayer thin film is exposed to broadband electromagnetic radiation and viewed from angles between 0° and 45° relative to a direction normal to an outer surface of the multilayer thin film.

12. The multilayer thin film of claim 11, wherein the reflective core layer is formed from Al, Ag, Pt, Sn, Au, Cu, brass, bronze, TiN, Cr, or combinations thereof.

13. The multilayer thin film of claim 11, wherein the reflective core layer has a thickness between 50 nm and 200 nm.

14. The multilayer thin film of claim 11, wherein the protective layer is formed from SiO₂, ZrO₂, CeO₂, Al₂O₃, or combinations thereof.

15. The multilayer thin film of claim 11, wherein the protective layer has a thickness between 5 nm and 70 nm.

16. The multilayer thin film of claim 11, wherein the dielectric absorbing layer is formed from Fe₂O₃, TiN, or combinations thereof.

17. The multilayer thin film of claim 11, wherein the dielectric absorbing layer has a thickness between 5 nm and 500 nm.

18. The multilayer thin film of claim 11, wherein the semi-transparent absorbing layer is formed from W, Cr, Ge, Ni, stainless steel, Pd, Ti, Si, V, TiN, Co, Mo, Nb, ferric oxide, amorphous silicon, or combinations thereof.

19. The multilayer thin film of claim 11, wherein the semi-transparent absorbing layer has a thickness from 5 nm to 20 nm.

20. The multilayer thin film of claim 11, wherein the outer layer is formed from a dielectric absorbing material selected from the group consisting of Fe₂O₃, TiN, or combinations thereof.

21. The multilayer thin film of claim 20, wherein the outer layer has a thickness between 5 nm and 500 nm.

22. The multilayer thin film of claim 11, wherein
the reflective core layer is formed from Al,
the protective layer is formed from SiO₂,
the dielectric absorbing layer is formed from Fe₂O₃,
the semi-transparent absorbing layer is formed from W, and
the outer layer is formed from Fe₂O₃, ZnS, or TiO₂.
